(19) United States
(12) Patent Application Publication
(10) Pub. No.: US 2024/0361633 A1
(43) Pub. Date: Oct. 31, 2024

(54) DISPLAY DEVICE

(71) Applicant: Sharp Display Technology Corporation, Kameyama City (JP)

(72) Inventors: Tomonori YOSHIDA, Kameyama City (JP); Kiyoshi Minoura, Kameyama City (JP); Osamu Itoh, Kameyama City (JP)

(21) Appl. No.: 18/595,620

(22) Filed: Mar. 5, 2024

(30) Foreign Application Priority Data
Apr. 28, 2023 (JP) 2023-074518

(51) Int. Cl. G02F 1/1335; G02F 1/13357

(52) U.S. Cl. CPC G02F 1/133514; G02F 1/133603; G02F 1/133614; G02F 1/133615; G02F 2201/123

(57) ABSTRACT

A display device includes a first light emitting component emitting light having a first wavelength in a wavelength range of blue light as a dominant wavelength, a second light emitting component emitting light having a second wavelength that is in the wavelength range of blue light as a dominant wavelength and longer than the first wavelength, first and second color filters that are disposed on a light exit side with respect to the first and second light emitting components and selectively transmit blue light in the wavelength range of blue light. The first color filter has a transmission spectrum in which a peak wavelength is a third wavelength in the wavelength range of blue light and the second color filter has a transmission spectrum in which a peak wavelength is a fourth wavelength in the wavelength range of blue light. The fourth wavelength is longer than the third wavelength.

### CROSS REFERENCE TO RELATED APPLICATION

This application claims priority from Japanese Patent Application No. 2023-074518 filed on Apr. 28, 2023. The entire contents of the priority application are incorporated herein by reference.

### TECHNICAL FIELD

The present technology described herein relates to a display device.

### BACKGROUND

A display device including a backlight has been known as one example of display devices. The display device includes a backlight and a pixel array. The backlight is configured to have a high circadian stimulation backlight spectrum having a spectral power distribution (SPD) with an overall power and a blue range from 440 nm to 490 nm with a blue SPD power of at least 25% of the overall power. The pixel array includes at least three filters that include a first filter, a second filter, and a third filter and includes at least three sub-pixels. The backlight is configured to supply light to the pixel array and the display light has a gamut having an sRGB coverage of at least 85%.

In the display including the backlight described above, the backlight includes violet LEDs and long blue light LEDs having different dominant wavelengths. For example, by adjusting the amount of light rays emitted by the violet LEDs and the amount of light rays emitted by the long blue light LEDs, images can be displayed with using light that matches circadian rhythm. However, with the amount of light rays emitted by the violet LEDs and the amount of light rays emitted by the long blue light LEDs being changed, the chromaticity related to a white color of the display image may be also changed. Therefore, the tint of the display image may be changed according to the time period in a day when the image is displayed. This may deteriorate display quality.

### SUMMARY

An object of the present disclosure is to improve display quality.

(1) A display device according to the present disclosure includes a first light emitting component emitting light having a first wavelength that is included in a wavelength range of blue light as a dominant wavelength, a second light emitting component emitting light having a second wavelength that is included in the wavelength range of blue light as a dominant wavelength and is longer than the first wavelength, a first color filter, and a second color filter. The first color filter and the second color filter are disposed on a light exit side with respect to the first light emitting component and the second light emitting component and selectively transmits blue light in the wavelength range of blue light. The first color filter has a transmission spectrum in which a peak wavelength is a third wavelength in the wavelength range of blue light. The second color filter has a transmission spectrum in which a peak wavelength is a fourth wavelength in the wavelength range of blue light and the fourth wavelength is longer than the third wavelength.

(2) In addition to (1), in the display device, a ratio of an area of the first color filter to a total of an area of the first color filter and an area of the second color filter may be defined as a first area ratio, a ratio of peak intensity in the transmission spectrum of the first color filter to a total of peak intensity in the transmission spectrum of the first color filter and peak intensity in the transmission spectrum of the second color filter may be defined as a first peak intensity ratio, and the first area ratio or the first peak intensity ratio of the first color filter may be in a range from 12% to 68%.

(3) In addition to (2), in the display device, the first area ratio or the first peak intensity ratio of the first color filter may be in a range from 20% to 60%.

(4) In addition to (3), in the display device, the first area ratio or the first peak intensity ratio of the first color filter may be in a range from 30% to 50%.

(5) In addition to any one of (1) to (4), the display device may further include a lighting device supplying light and a display panel displaying an image with using the light from the lighting device. The lighting device may include the first light emitting component, the second light emitting component, and a wavelength conversion portion that is disposed on the light exit side with respect to the first light emitting component and the second light emitting component and converts blue light in the wavelength range of blue into light in a wavelength ranging from green to red. The display panel may include the first color filter, the second color filter, a third color filter that selectively transmits green light that is light in a wavelength range of green, and a fourth color filter that selectively transmits red light that is light in the wavelength range of red.

(6) In addition to (5), in the display device, the display panel may include pixel electrodes and the pixel electrodes may include a first pixel electrode that is disposed to overlap the first color filter and the second color filter, a second pixel electrode that is disposed to overlap the third color filter, and a third pixel electrode that is disposed to overlap the fourth color filter.

(7) In addition to (6), in the display device, the first color filter may be disposed to overlap a portion of the first pixel electrode and the second color filter may be disposed to overlap a rest of the first pixel electrode and next to the first color filter.

(8) In addition to (5), in the display device, the display panel may include pixel electrodes and the pixel electrodes may include a fourth pixel electrode that is disposed to overlap the first color filter, a fifth pixel electrode that is disposed to overlap the second color filter, a sixth pixel electrode that is disposed to overlap the third color filter, and a seventh pixel electrode that is disposed to overlap the fourth color filter.

(9) In addition to (8), in the display device, the fourth pixel electrode and the fifth pixel electrode may have a same area, and the first color filter and the second color filter may have a same area and at least one of a thickness and a density of included pigment or dye may differ between the first color filter and the second color filter.

(10) In addition to (8), in the display device, the first color filter and the second color filter may have different areas.

(11) In addition to any one of (5) to (10), in the display device, the lighting device may include a light source, and the light source may include the first light emitting component and the second light emitting component, a case in which the first light emitting component and the second light emitting component are stored, and a sealing portion with which the case is filled and the first light emitting component and the second light emitting component are enclosed.

(12) In addition to (11), in the display device, the wavelength conversion portion may include phosphor included in the sealing portion.

(13) In addition to any one of (1) to (12), in the display device, the first wavelength of the first light emitting component may be in a range from 420 nm to 450 nm, and the second wavelength of the second light emitting component may be in a range from 450 nm to 480 nm.

According to the technology described herein, display quality can be improved.

### BRIEF DESCRIPTION OF THE DRAWINGS

FIG. 1 is a side view of a liquid crystal display device according to a first embodiment.

FIG. 2 is a cross-sectional view illustrating a liquid crystal panel and a backlight unit included in the liquid crystal display device.

FIG. 3 is a cross-sectional view of a display area of the liquid crystal panel.

FIG. 4 is a cross-sectional view of an LED included in the backlight unit.

FIG. 5 is a graph of a light emission spectrum of the LED according to the first embodiment with a first LED component being on and a second LED component being off.

FIG. 6 is a graph of a light emission spectrum of the LED according to the first embodiment with the amount of light rays emitted by the first LED component being same as the amount of light rays emitted by the second LED component.

FIG. 7 is a graph of a light emission spectrum of the LED according to the first embodiment with the second LED component being on and the first LED component being off.

FIG. 8 is a CIE 1931 chromaticity diagram illustrating first chromaticity, second chromaticity, and third chromaticity according to the first embodiment.

FIG. 9 is a plan view of an opposing substrate included in the liquid crystal panel.

FIG. 10 is a cross-sectional view of the liquid crystal panel taken along line x-x in FIG. 9.

FIG. 11 is a graph of transmission spectrums of color filters.

FIG. 12 is a graph illustrating experiment results of Verification Experiment 1 according to the first embodiment.

FIG. 13 is a plan view of an opposing substrate according to a second embodiment.

FIG. 14 is a cross-sectional view of a liquid crystal panel according to the second embodiment taken along line xiv-xiv in FIG. 13.

FIG. 15 is a cross-sectional view of the liquid crystal panel according to the second embodiment taken along line xv-xv in FIG. 13.

FIG. 16 is a graph of transmission spectrums of the color filters according to the second embodiment.

FIG. 17 is a graph illustrating experiment results of Verification Experiment 2 according to the second embodiment.

FIG. 18 is a plan view of an opposing substrate according to a third embodiment.

FIG. 19 is a cross-sectional view of a liquid crystal panel according to the third embodiment taken along line xix-xix in FIG. 18.

FIG. 20 is a graph illustrating experiment results of Verification Experiment 3 according to the third embodiment.

### DETAILED DESCRIPTION

### First Embodiment

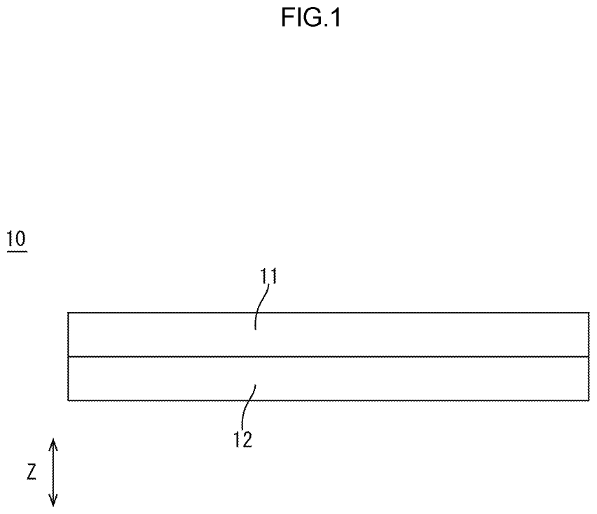

A first embodiment will be described with reference to FIGS. 1 to 12. In the embodiment section, a liquid crystal display device 10 (a display device) will be described as an example. An X-axis, a Y-axis and a Z-axis may be present in the drawings and each of the axial directions represents a direction represented in each drawing. An upper side and a lower side in FIGS. 1 to 4 and FIG. 10 correspond to a front side and a back side, respectively.

As illustrated in FIG. 1, the liquid crystal display device 10 includes a liquid crystal panel 11 (a display panel) displaying images thereon and a backlight unit 12 (a lighting device) that is disposed behind (on a back side of) the liquid crystal panel 11 and supplies light to the liquid crystal panel 11 for display. The liquid crystal panel 11 and the backlight unit 12 that are overlapped with each other are held by a holding member.

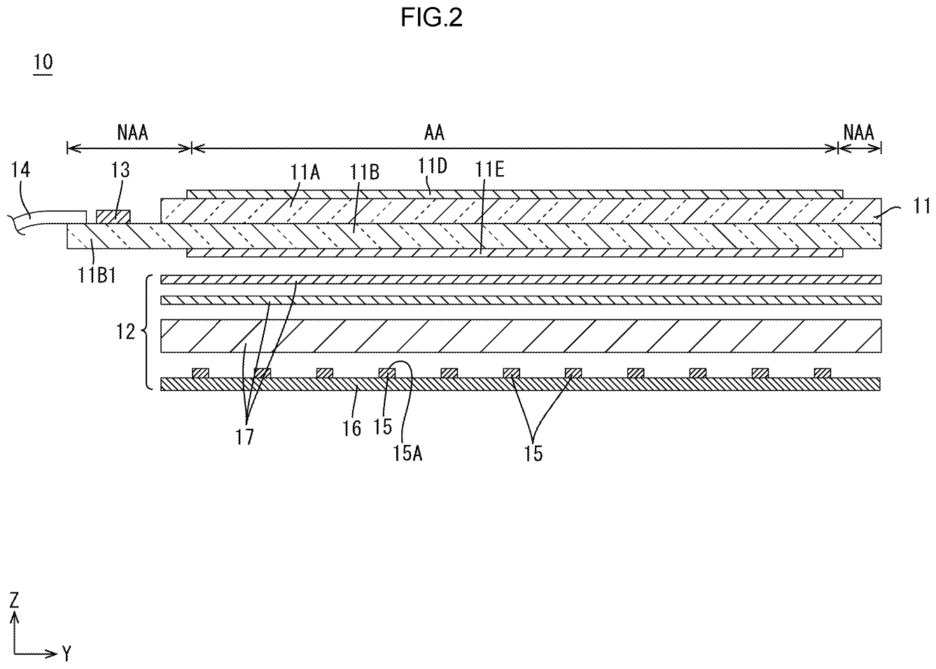

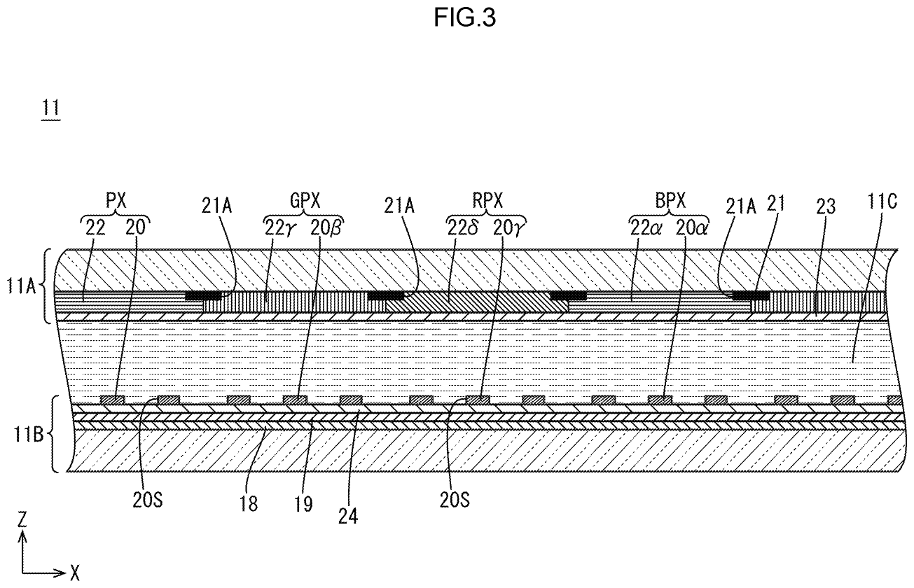

As illustrated in FIG. 2, the liquid crystal panel 11 is disposed on a front side (a light exit side) with respect to the backlight unit 12. The liquid crystal panel 11 includes a pair of substrates 11A, 11B that are bonded each other and liquid crystal layer 11C (refer to FIG. 3) that is enclosed in a space between the glass substrates 11A, 11B. A front side (a front-surface side) one of the glass substrates 11A, 11B is an opposing substrate 11A and a rear side (a back-surface side) one is an array substrate 11B. Alignment films are disposed on inner surfaces of the opposing substrate 11A and the array substrate 11B, respectively. Polarizing plates 10D, 10E are attached to outer surfaces of the opposing substrate 11A and the array substrate 11B, respectively.

As illustrated in FIG. 2, the liquid crystal panel 11 includes a display area AA that displays an image and a non-display area NAA that displays no image. The display area AA is a middle portion of a main surface of the liquid crystal panel 11 and the non-display area NAA is an outer peripheral portion that surrounds the display area AA. The array substrate 11B is greater than the opposing substrate 11A and includes an extending portion 11B1 that extends laterally further from an edge of the opposing substrate 11A. The extending portion 11B1 is not overlapped with the opposing substrate 11A and uncovered. An entire area of the extending portion 11B1 is a portion of the non-display area NAA and a driver 13 for supplying various kinds of signals and a flexible circuit board 14 are mounted on the extending portion 11B1.

As illustrated in FIG. 2, the backlight unit 12 is a so-called direct-type backlight unit. The backlight unit 12 has a main surface (a light exit surface) that is opposite a back surface of the liquid crystal panel 11. The light exit surface of the backlight unit 12 includes a middle portion that overlaps the display area AA of the liquid crystal panel 11 in a plan view and the middle portion of the light exit surface is a light exit area from which light exits. The light exit surface of the backlight unit 12 includes an outer peripheral portion that overlaps the non-display area NAA of the liquid crystal panel 11 in a plan view and the outer peripheral portion of the light exit surface is a non-light exit area from which light is less likely to exit. The backlight unit 12 at least includes light emitting diodes (LEDs) 15 that are configured as a light source, a LED board 16 (a light source board) on which the LEDs 15 are mounted, and an optical member 17 for adding optical effects to the light emitted by the LEDs 15.

As illustrated in FIG. 2, the LEDs 15 are surface-mounted on the LED board 16. Each LED 15 is a so-called top-surface-emitting type LED. The LED 15 is disposed such that a light emission surface 15a faces an opposite side from the LED board 16 (faces the front side or an optical member 17 side). An optical axis of the LEDs 15 matches the Z-axis direction. The “optical axis” in this specification is referred to as an axis of light rays that matches a traveling direction of light rays having highest light emission strength (having a peak) among the light rays emitted by the LEDs 15. In this embodiment, white LEDs emitting white light exerting white color as a whole are used as the LEDs 15. A specific configuration of the LED 15 will be described later.

As illustrated in FIG. 2, the LED board 16 is a plate member or a film member having a surface extending parallel to the surface of the liquid crystal panel 11. The LEDs 15 are surface-mounted on one of a pair of surfaces of the LED board 16 facing the front side and the one surface facing the front side is a mounting surface. The LEDs 15 are arranged at intervals in the X-axis direction and the Y-axis direction within a plane surface of the front side surface of the LED board 16. The LEDs 15 may be arranged in a matrix or in a zig-zag manner.

As illustrated in FIG. 2, the optical member 17 is a plate member or a sheet member having a surface extending parallel to the surfaces of the liquid crystal panel 11 and the LED board 16. The optical member 17 is disposed away from the LEDS 15 and is on the front side with respect to the LEDs 15 in the Z-axis direction. The light emitted by the LEDs 15 passes through the optical member 17 with receiving optical effects from the optical member 17 and exits the optical member 17 toward the liquid crystal panel 11. The optical member 17 includes three members that are disposed on top of each other in FIG. 2. The three optical members 17 include a diffuser plate, a prism sheet, and a diffuser sheet. The diffuser plate and the diffuser sheet are configured to diffuse light that entered the diffuser plate and the diffuser sheet and the diffused light exits the diffuser plate and the diffuser sheet. The prism sheet is configured to collect the light rays that enter the prism sheet and the collected light rays exit the prism sheet.

Next, a general cross-sectional configuration of the display area AA of the liquid crystal panel 11 will be described with reference to FIG. 3. As illustrated in FIG. 3, in the display area AA, the array substrate 11B includes a pixel circuit portion 18, a common electrode 19, and pixel electrodes 20 on an inner surface side thereof. The pixel circuit portion 18 includes circuit components (such as TFTs), which are for driving pixels PX, and lines (gate lines and source lines). The common electrode 19 is disposed in a solid manner on a substantially entire area of the surface of the array substrate 11B to overlap all the pixel electrodes 20. The common electrode 19 is supplied with a common potential signal of a common potential (a reference potential) by the pixel circuit portion 18. The pixel electrode 20 is a portion of the pixel PX and the pixel electrodes 20 are arranged in rows and columns within the surface area of the array substrate 11B. All the pixel electrodes 20 have a substantially same area (a same plan view size). The common electrode 19 and the pixel electrodes 20 are made of a transparent electrode material such as indium tin oxide (ITO). The pixel electrodes 20 are connected to the TFTs included in the pixel circuit portion 18 and are charged at certain potentials (potentials based on image signals supplied to the source lines). The pixel electrodes 20 are included in an upper layer (disposed closer to the liquid crystal layer 11C) than the common electrode 19 via an insulating film 24. The pixel electrode 20 has slits 20S. With the pixel electrodes 20 being charged, a potential difference occurs between the pixel electrode 20 and the common electrode 19. When a potential difference occurs between the pixel electrode 20 and the common electrode 19, a fringe field (an oblique field) including a component in a direction normal to a plate surface of the array substrate 11B is created between an opening edge of the slit 20S of the pixel electrode 20 and the common electrode 19 in addition to a component in a direction along the plate surface of the array substrate 11B. Alignment of the liquid crystal molecules in the liquid crystal layer 11C can be properly controlled with utilizing the fringe field and predetermined display can be performed based on the alignment of the liquid crystal molecules. The liquid crystal panel 11 of this embodiment operates in a fringe field switching (FFS) mode.

As illustrated in FIG. 3, in the display area AA, a light blocking portion 21 (black matrix), color filters 22, and an overcoat layer 23 are disposed on the inner surface side of the opposing substrate 11A. The color filters 22 are disposed to overlap the pixel electrodes 20 and exhibit three different colors of red (R), green (G), and blue (B). The color filter 22 includes pigment of a color to be exhibited and is configured such that the pigment absorbs non-exhibiting colors and selectively transmit the light of the color to be exhibited (light of a specific color). The color filter 22 and the pixel electrode 20 that are opposite each other are configured as a pixel PX, which is a display unit. The pixels PX include blue pixels BPX (a first pixel) exhibiting blue, green pixels GPX (a second pixel) exhibiting green, and red pixels RPX (a third pixel) exhibiting red. The liquid crystal panel 11 can perform color display in predefined tones with the pixels GPX, BPX, RPX of the three colors. The light blocking portion 21 has a grid shape that defines each of the adjacent color filters 22. The light blocking portion 21 has openings 21A in portions thereof overlapping the respective color filters 22 (the respective pixel electrodes 20). Light is blocked by the light blocking portion 21 but can pass through the openings 21A. The openings 21A are arranged in rows and columns at intervals in the X-axis direction and the Y-axis direction within a plane surface of the opposing substrate 11A. All the openings 21A have a substantially same opening area (a plan view size). The light blocking portion 21 is disposed to surround each pixel PX to prevent color mixture between the pixels PX. An overcoat film 23 is disposed in a solid manner on a substantially entire area of the opposing substrate 11A for planarization of the inner surface of the opposing substrate 11A. Alignment films for orienting the liquid crystal molecules in the liquid crystal layer 11C are formed on, respectively, innermost surfaces of the substrates 11A, 11B.

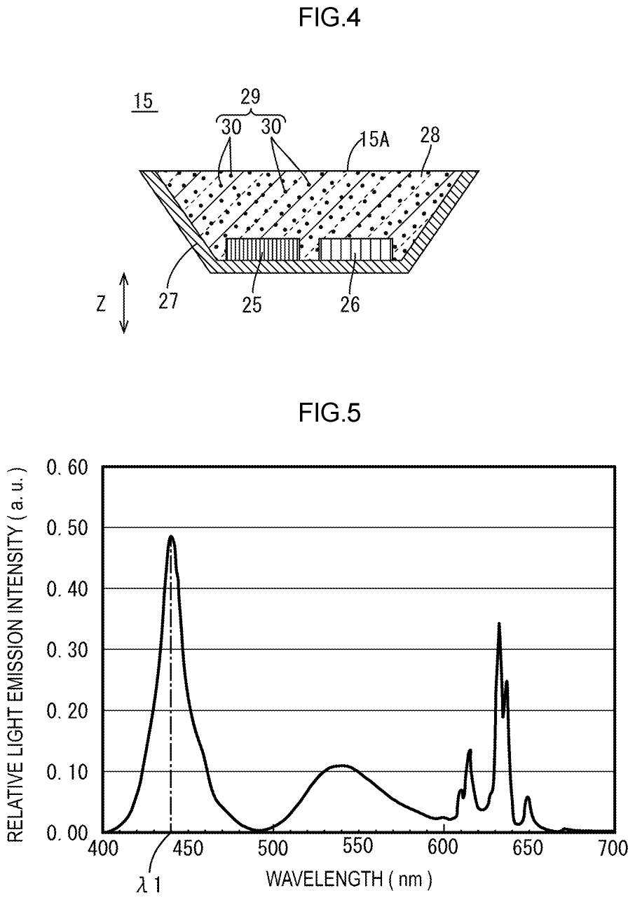

Next, a detailed configuration of the LED 15 will be described with reference to FIG. 4. As illustrated in FIG. 4, the LED 15 includes two LED components 25, 26 (light emitting component), a case 27 storing the LED components 25, 26, and a sealing portion 28 for sealing the LED components 25, 26 in the case 27. The case 27 has a tubular shape with a bottom and opens toward the front side. The sealing portion 28 is made of resin material having good light transmissive properties (for example, epoxy resin, silicone resin). With the case 27 being filled with the sealing portion 28, the sealing portion 28 covers the opening of the case 27 and is configured as a light emitting surface 15A.

As illustrated in FIG. 4, the LED components 25, 26 include a first LED component 25 (a first light emitting component) and a second LED component 26 (a second light emitting component). The first LED component 25 and the second LED component 26 are blue LED components that emit single blue light in a wavelength range of blue light (about 420 nm to about 500 nm). The first LED component 25 and the second LED component 26 have different dominant wavelengths. Specifically, the dominant wavelength of the first LED component 25 is a first wavelength λ1 included in the wavelength range of blue light and the dominant wavelength of the second LED component 26 is a second wavelength λ2 that is included in the wavelength range of blue light and longer than the first wavelength λ1. The first wavelength λ1, which is the dominant wavelength of the first LED component 25, is 440 nm, for example. The second wavelength λ2, which is the dominant wavelength of the second LED component 26, is 470 nm, for example. Difference between the first wavelength λ1 and the second wavelength λ2 is 30 nm, for example.

As illustrated in FIG. 4, the LED 15 includes a wavelength conversion portion 29 that converts the wavelength of a portion of blue light rays emitted by each of the LED components 25, 26. Specifically, the wavelength conversion portion 29 includes phosphors 30 contained in the sealing portion 28. The phosphors 30 are dispersed in the sealing portion 28 at a predetermined distribution density. The phosphors 30 include green phosphors that convert blue light rays into green light rays having the wavelength range of green (from about 500 nm to about 570 nm) and red phosphors that convert blue light rays into red light rays having the wavelength range of red (from about 600 nm to about 780 nm). Sialon phosphors may be used as the green phosphors, for example. Rare-earth elements (such as Tb, Yb, Ag) can be used as an activator for sialon phosphors. β-SiAlON may be used for sialon phosphors, for example. β-SiAlON is a substance represented by a general formula of SiO_{6-Z}Al_{Z}O_{Z}N_{8-Z} (Z represents the amount of solid solution) or (Si, Al)₆(O, N)₈ where β-silicon nitride crystals contain aluminum and oxygen in the form of solid solution. Europium (Eu) that is one kind of the rare-earth elements is used as the activator for β-SiAlON. Complex fluoride phosphors may be used as the red phosphors, for example. Complex fluoride phosphors are represented by a general formula of A₂MF₆ (M is one or more kinds selected from Si, Ti, Ar, Hf, Ge, and Sn, A is one or more kinds selected from Li, Na, K, Rb, and Cs). Manganese-activated potassium silicofluoride (K₂SiF₆: Mn) may be used for the complex fluoride phosphors.

The LED 15 having the configuration described above is connected to an external LED control circuit (a light source control circuit) and supplying of power to the LEDs 15 and driving of the LEDs 15 are controlled by the LED control circuit. The LED control circuit can control supplying of power to the first LED component 25 and the second LED component 26 independently and control the amount of light rays emitted by the first LED component 25 and the second LED component 26 independently. The LED control circuit may control the amount of light rays emitted by each of the first LED component 25 and the second LED component 26 with pulse width modulation (PWM). Specifically, the LED control circuit supplies pulse signals to the first LED component 25 and the second LED component 26 and adjusts the time ratio (a duty ratio) of the ON period (a lighting period) and the OFF period (a non-lighting period) of each of the first LED component 25 and the second LED component 26. Accordingly, the amount of light rays emitted by each of the first LED component 25 and the second LED component 26 per a unit time period can be controlled.

Humans control periodical phenomena related to the biological functions based on the clock mechanism that is called body's internal clock and the circadian rhythm is known as one of the periodical phenomena. The circadian rhythm is related to essential functions for maintaining the biological functions such as body temperature, hormone production, sleep and wake. The melatonin production is deeply related to the sleep-wake cycle and the melatonin production level is low when humans are awake. Light stimulation to the retina affects the melatonin production and the melatonin production tends to be affected by the wavelength of blue light that is included in the wavelength range of blue. Specifically, with the retina being affected by the blue light in the wavelength range of about 470 nm, the melatonin production tends to be smallest. Therefore, if the retina is highly stimulated by the blue light in the wavelength range of about 470 nm in the nighttime and melatonin is less likely to be produced, the sleep-wake rhythm is likely to be disordered, health problems such as sleep disorder may be caused.

In this respect, the LED control circuit, which is previously described, can appropriately control the amount of light rays emitted by each of the first LED component 25 and the second LED component 26 and the ratio of the amount of light rays emitted by the first LED component 25 and the amount of light rays emitted by the second LED component 26 according to the time period in a day (for example, morning, daytime, nighttime, late night) or the time. Specifically, for example, in the morning, the LED control circuit turns off the first LED component 25 and turns on the second LED component 26 such that the melatonin production of a user of the liquid crystal display device 10 can be reduced to keep the user awake. On the other hand, in the nighttime or the late night, for example, the LED control circuit turns on the first LED component 25 and the second LED component 26 such that the reduction of the melatonin production of a user of the liquid crystal display device 10 can be suppressed and the user can sleep easily. According to the liquid crystal display device 10 of this embodiment, the light that is appropriate for the circadian rhythm of humans can be supplied to the liquid crystal panel 11 and an image can be displayed on the liquid crystal panel 11 with using such light. Accordingly, the body's internal clock of a user of the liquid crystal display device 10 is less likely to be disordered and the health problems such as sleep disorder are less likely to be caused.

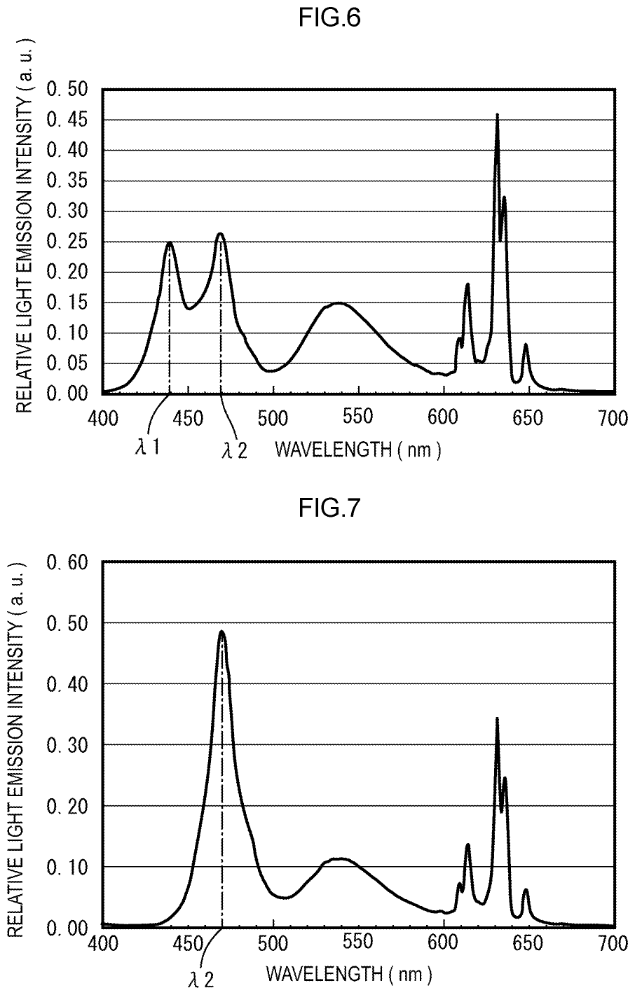

Next, specific examples of light emission spectrums of the LED 15 are illustrated in FIGS. 5 to 7. The lateral axis represents wavelengths of the light rays (the unit is nm) and the vertical axis represents relative light emission intensity (no unit). FIG. 5 illustrates a light emission spectrum of the LED 15 with the first LED component 25 being on and the second LED component 26 being off. In FIG. 5, the on-period of the first LED component 25 is 100% and the off-period of the first LED component 25 is 0%, and the on-period of the second component 26 is 0% and the off-period of the second LED component 26 is 100%. FIG. 6 illustrates a light emission spectrum of the LED 15 with the amount of light rays emitted by the first LED component 25 being same as the amount of light rays emitted by the second LED component 26. In FIG. 6, the on-period of the first LED component 25 is 50% and the off-period of the first LED component 25 is 50%, and the on-period of the second component 26 is 50% and the off-period of the second LED component 26 is 50%. FIG. 7 illustrates a light emission spectrum of the LED 15 with the second LED component 26 being on and the first LED component 25 being off. In FIG. 7, the on-period of the first LED component 25 is 0% and the off-period of the first LED component 25 is 100%, and the on-period of the second component 26 is 100% and the off-period of the second LED component 26 is 0%.

According to FIG. 5, with only the first LED component 25 being on, blue light having the peak wavelength of 440 nm in the wavelength range of blue and the peak relative light emission intensity of about 0.5 is emitted. According to FIG. 6, with the first LED component 25 and the second LED component 26 being on, blue light having two peak wavelengths of 440 nm and 470 nm in the wavelength range of blue and the peak relative light emission intensity of about 0.25 is emitted. According to FIG. 7, with only the second LED component 26 being on, blue light having the peak wavelength of 470 nm in the wavelength range of blue and the peak relative light emission intensity of about 0.5 is emitted. As illustrated in FIGS. 5 to 7, with the LED control circuit appropriately controlling the amount of light rays emitted from each of the first LED component 25 and the second LED component 26, the light emission spectrum of blue light can be controlled.

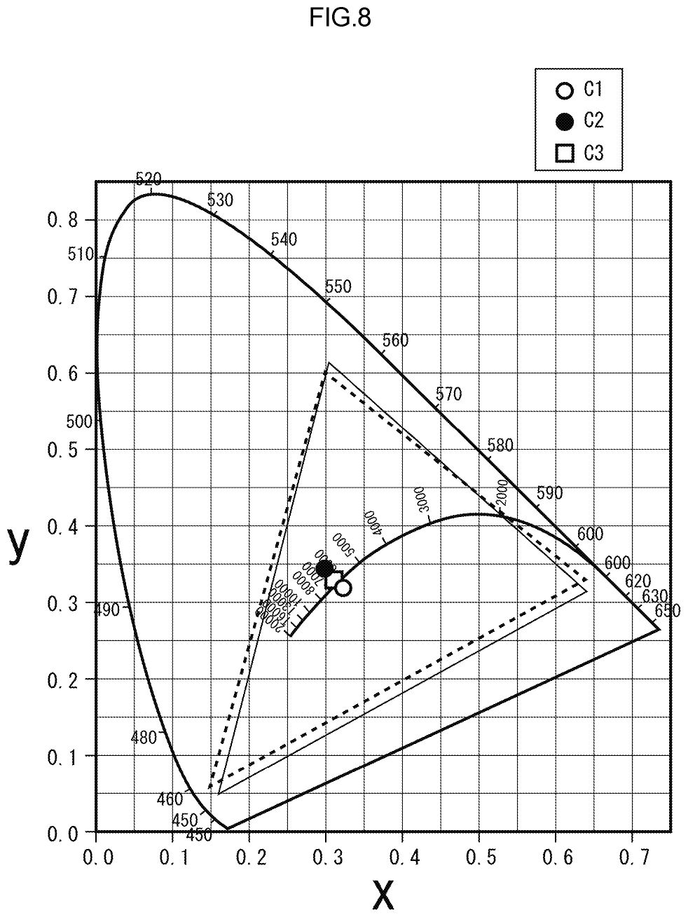

With the LED control circuit controlling the amount of light rays emitted by each of the first LED component 25 and the second LED component 26, as previously described, the chromaticity regarding the light rays emitted by the LED 15 may be changed. The change of the chromaticity related to a white color will be described with reference to FIG. 8. FIG. 8 illustrates a CIE (Commission Internationale de l'Eclairage) 1931 chromaticity diagram. In FIG. 8, the x-axis and the y-axis, which are a lateral axis and a vertical axis, respectively, represent x values and y values in the chromaticity diagram. FIG. 8 illustrates first chromaticity C1, second chromaticity C2, and third chromaticity C3. The first chromaticity C1 represents chromaticity of light emitted by the LED 15 with only the first LED component 25 being on. The second chromaticity C2 represents chromaticity of light emitted by the LED 15 with only the second LED component 26 being on. The third chromaticity C3 represents chromaticity of light emitted by D65 light source. In FIG. 8, a chromaticity region of the image displayed on the liquid crystal panel 11 with only the first LED component 25 being on is illustrated with a solid line and a sRGB chromaticity region defined by sRGB, which is a standard color space, is illustrated with a dotted line. The sRGB is a standard defined by International Electrotechnical Commission (IEC), which is an international organization for standardization, in 1998.

According to FIG. 8, the x value of the second chromaticity C2 is smaller than that of the first chromaticity C1 and the y value of the second chromaticity C2 is greater than that of the first chromaticity C1. The chromaticity shift of the light emitted by the LED 15 is caused along a line connecting the first chromaticity C1 and the second chromaticity C2 according to the ratio of the amounts of light rays emitted by the first LED component 25 and the second LED component 26. Specifically, with the ratio of the amount of light rays emitted by the second LED component 26 to the amount of light rays emitted by the first LED component 25 being increased, the chromaticity of the light emitted by the LED 15 is changed to be closer to the second chromaticity C2 along the above-described line. With the ratio of the amount of light rays emitted by the second LED component 26 to the amount of light rays emitted by the first LED component 25 being decreased, the chromaticity of the light emitted by the LED 15 is changed to be closer to the first chromaticity C1 along the above-described line. The third chromaticity C3 is at a middle between the first chromaticity C1 and the second chromaticity C2. Thus, with the chromaticity of the light emitted by the LED 15 being changed according to the ratio of the amount of light rays emitted by the first LED component 25 and the amount of light rays emitted by the second LED component 26, the tint of an image displayed on the liquid crystal panel 11 is also changed and the display quality becomes lower.

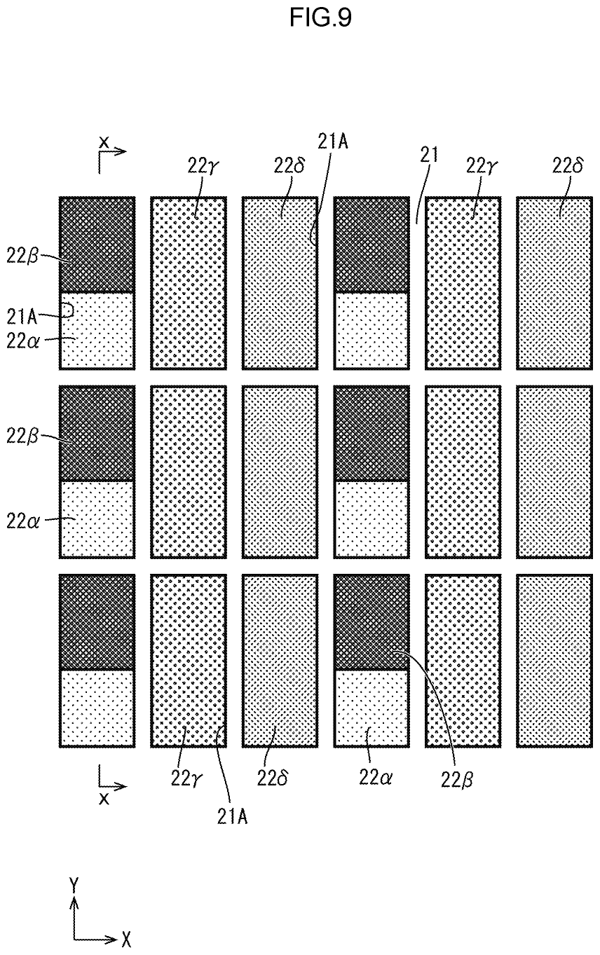

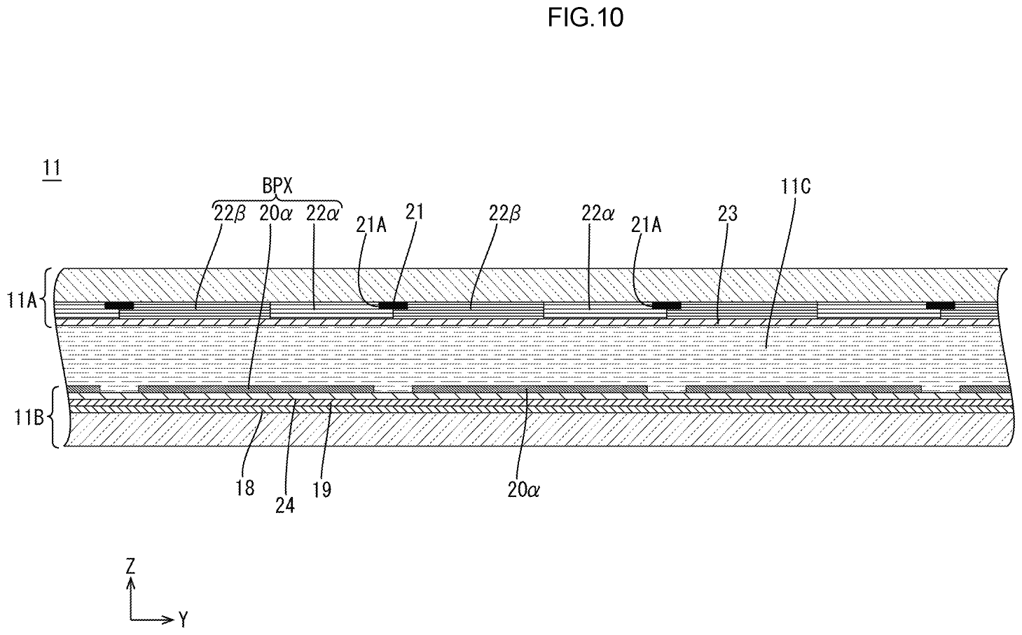

As illustrated in FIGS. 9 and 10, the liquid crystal panel 11 according to this embodiment includes two types of color filters 22α, 22β as the color filters 22. The color filters 22α, 22β selectively transmit blue light that is light in the wavelength range of blue. The color filters 22α, 22β include a first color filter 22α and a second color filter 22β. The first color filter 22α has transmission spectrum in which a peak wavelength is defined as a third wavelength λ3 included in the wavelength range of blue. The second color filter 22β has a transmission spectrum in which a peak wavelength is defined as a fourth wavelength λ4 included in the wavelength range of blue and the fourth wavelength λ4 is longer than the third wavelength λ3. The first color filter 22α and the second color filter 22β include different pigments. In addition to the first color filter 22α and the second color filter 22β, the color filters 22 further include a third color filter 22γ that selectively transmits green light that is light in the wavelength range of green and a fourth color filter 22δ that selectively transmits red light that is light in the wavelength range of red. In FIG. 9, the color filters 22α, 22β, 22γ, 22δ are illustrated with different shadings for clarification. In the following description, to describe each of the color filters 22 separately, α is added to the symbol representing the first color filter, β is added to the symbol representing the second color filter, γ is added to the symbol representing the third color filter, and δ is added to the symbol representing the fourth color filter, and no additional symbol is added to generally refer to the color filters.

In the transmission spectrum of the first color filter 22α, the peak wavelength is the third wavelength λ3 included in the wavelength range of blue. In the transmission spectrum of the second color filter 22β, the peak wavelength is the fourth wavelength λ4 included in the wavelength range of blue. The fourth wavelength λ4 is longer than the third wavelength λ3. Therefore, even with the amount of light rays emitted by the first LED component 25 and the amount of light rays emitted by the second LED component 26 being changed, the amount of chromaticity shift that may be caused in the chromaticity related to a white color of the display image is reduced. This improves display quality.

As illustrated in FIG. 9, the first color filter 22α and the second color filter 22β are arranged next to each other along the Y-axis direction within one opening 21A. Therefore, each area (a plan view size) of the first color filter 22α and the second color filter 22β is smaller than an area of the opening 21A. The first color filter 22α and the second color filter 22β having such configurations are disposed on the opposing substrate 11A with the known photolithography method. With the area of the opening 21A being 100%, the area ratio of the first color filter 22α is about 40% and the area ratio of the second color filter 22 is about 60%. The first color filter 22α and the second color filter 22β have a same dimension in the X-axis direction and different dimensions in the Y-axis direction. The first color filters 22α and the second color filters 22β are arranged in the Y-axis direction. The third color filter 22γ is disposed in one opening 21A and the area of the third color filter 22γ is same as the area of the opening 21A. The third color filters 22γ are arranged in the Y-axis direction. The fourth color filter 22δ is disposed in one opening 21A and the area of the fourth color filter 22δ is same as the area of the opening 21A. The fourth color filters 22δ are arranged in the Y-axis direction. The first color filter 22α and the second color filter 22β, the third color filter 22γ, and the fourth color filter 22δ that exhibit different colors are arranged next to each other in the X-axis direction with sandwiching a portion of the light blocking portion 21 that extends in the Y-axis direction. In a configuration in which the first color filter 22α and the second color filter 22β are formed with the photolithography method, the third color filter 22γ and the fourth color filter 22δ are formed on the opposing substrate 11A with the photolithography method.

As illustrated in FIGS. 3 and 10, the pixel electrodes 20 included in the liquid crystal panel 11 include a first pixel electrode 20α that is disposed to overlap the first color filter 22α and the second color filter 22β, a second pixel electrode 20β that is disposed to overlap the third color filter 22γ, and a third pixel electrode 20γ that is disposed to overlap the fourth color filter 22δ. In the following description, to describe each of the pixel electrodes 20 separately, α is added to the symbol representing the first pixel electrode, β is added to the symbol representing the second pixel electrode, γ is added to the symbol representing the third pixel electrode, and no additional symbol is added to generally refer to the pixel electrodes. The first color filter 22α is disposed to overlap a portion of the first pixel electrode 20α. The second color filter 22β is disposed next to the first color filter 22α and overlaps a rest of the first pixel electrode 20α. The third color filter 22γ is disposed to overlap a substantially entire area of the second pixel electrode 20β. The fourth color filter 22δ is disposed to overlap a substantially entire area of the third pixel electrode 20γ. The first color filter 22α, the second color filter 22β, and the first pixel electrode 20α that are overlapped with each other are configured as a blue pixel BPX that exhibits blue. The third color filter 22γ and the second pixel electrode 20β that are overlapped with each other are configured as a green pixel GPX that exhibits green. The fourth color filter 22δ and the third pixel electrode 20γ that are overlapped with each other are configured as a red pixel RPX that exhibits red. Accordingly, the blue pixel BPX is displayed with the blue light including the light rays that pass through the first color filter 22α and the light rays that pass through the second color filter 22β. With comparing a configuration in which the first color filter 22α overlaps a substantially entire area of one pixel electrode and the second color filter 22β overlaps a substantially entire area of another pixel electrode, the light rays that pass through the first color filter 22α and the light rays that pass through the second color filter 22β are less likely to be separated from each other. Therefore, the change of tint that is caused by the changes of the amount of light rays emitted by the first LED component 25 and the amount of light rays emitted by the second LED component 26 is less likely to be recognized.

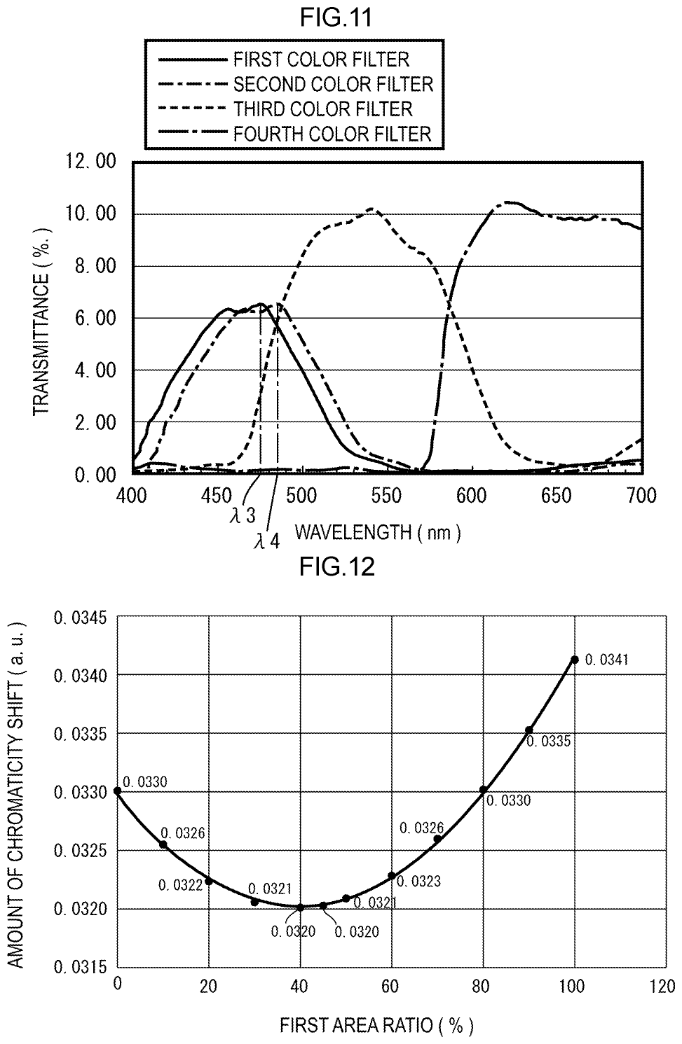

Next, the transmission spectrums of the first color filter 22α and the second color filter 22β will be described with reference to FIG. 11. FIG. 11 illustrates the transmission spectrums of the color filters 22α, 22β, 22γ, 22δ and the lateral axis represents wavelengths (the unit is nm) and the vertical axis represents transmittance of light (the unit is %). According to FIG. 11, the first color filter 22α and the second color filter 22β have a similar spectrum shape; however, the transmission spectrum of the second color filter 22β is shifted to the longer wavelengths with respect to the transmission spectrum of the first color filter 22α. The first color filter 22α and the second color filter 22β have transmission spectrums such that the peak intensity of the light having the peak wavelength is substantially same. The thickness of the filters and the density of the pigments included in the filters are adjusted to obtain the substantially same peak intensity. In the transmission spectrum of the first color filter 22α, the third wavelength γ3, which is a peak wavelength, is about 478 nm. In the transmission spectrum of the second color filter 22β, the fourth wavelength γ4, which is a peak wavelength, is about 488 nm. The transmission spectrum of the second color filter 22β is shifted to the longer wavelengths with respect to the transmission spectrum of the first color filter 22α by 10 nm. In the transmission spectrum of the third color filter 22γ, a peak wavelength is about 545 nm. In the transmission spectrum of the fourth color filter 22δ, a peak wavelength is about 620 nm.

Next, Verification Experiment 1 was performed to verify how chromaticity related to the white color of a display image changes when the area of each of the first color filter 22α and the second color filter 22β is changed. In Verification Experiment 1, the area ratio of the area of the first color filter 22α to the total of the areas of the first color filter 22α and the second color filter 22β is defined as a first area ratio. With the first area ratio being changed from 0% to 100%, the amounts of chromaticity shifts that may be caused in the chromaticity related to the white color of the display image were obtained. Specifically, in Verification Experiment 1, the first area ratio was set to 0%, 10%, 20%, 30%, 40%, 45%, 50%, 60%, 70%, 80%, 90%, 100%. With the first area ratio being 0%, only the second color filters 22β are formed and the first color filters 22α are not formed. With the first area ratio being 100%, only the first color filters 22α are formed and the second color filters 22β are not formed. The amount of chromaticity shift represents a distance between two chromaticities that are plotted on the CIE 1931 chromaticity diagram. The two chromaticities include chromaticity related to the white image displayed on the liquid crystal panel 11 with the first LED components 25 being on and the second LED components 26 being off and chromaticity related to the white image displayed on the liquid crystal panel 11 with the second LED components 26 being on and the first LED components 25 being off. The phosphors 30 included in the sealing portion 28 of the LED 15 are adjusted such that chromaticity related to the white image of a white image displayed on the liquid crystal panel 11 with the first LED components 25 being on and the second LED components 26 being off matches the chromaticity of a D65 light source (0.31271, 0.32902). The white image is defined as an image displayed with all the pixels PX of the liquid crystal panel 11 being at a highest gray scale level. Experiment results are illustrated in FIG. 12. FIG. 12 is a graph with the lateral axis representing the first area ratios (the unit is %) and the vertical axis representing the amounts of chromaticity shifts (no unit).

According to FIG. 12, with the first area ratio being lower than 12% or greater than 68%, the amount of chromaticity shift is greater than 0.0325. Therefore, the change of tint that is caused in the display image is likely to be recognized. Furthermore, the change ratio of the amount of chromaticity shift to the first area ratio is high. Therefore, if the first area ratio is changed due to a production error, the amount of chromaticity shift is largely changed and the change of tint caused in the display image may be likely to be recognized. In this respect, with the first area ratio being from 12% to 68%, the amount of chromaticity shift is suppressed to 0.0325 or smaller. Therefore, the change of tint caused in the display image is less likely to be recognized. The change ratio of the amount of chromaticity shift to the first area ratio is effectively low. Therefore, even if the first area ratio is changed due to a production error, only a small change is caused in the amount of chromaticity shift and the change of tint caused in the display image is less likely to be recognized.

According to FIG. 12, with the first area ratio being lower than 20% or greater than 60%, the amount of chromaticity shift is greater than 0.0323. With the first area ratio being from 20% to 60%, the amount of chromaticity shift is suppressed to 0.0323 or smaller. Therefore, the change of tint caused in the display image is further less likely to be recognized. The change ratio of the amount of chromaticity shift to the first area ratio becomes effectively lower. Therefore, even if the first area ratio is changed due to a production error, only a small change is caused in the amount of chromaticity shift and the change of tint caused in the display image is further less likely to be recognized.

According to FIG. 12, with the first area ratio being lower than 30% or greater than 50%, the amount of chromaticity shift is greater than 0.0321. With the first area ratio being from 30% to 50%, the amount of chromaticity shift is suppressed to 0.0321 or smaller. Therefore, the change of tint caused in the display image is further less likely to be recognized. The change ratio of the amount of chromaticity shift to the first area ratio becomes effectively much lower and the amount of chromaticity shift is less likely to change. Therefore, even if the first area ratio is changed due to a production error, only a small change is caused in the amount of chromaticity shift and the change of tint caused in the display image is further less likely to be recognized. Particularly, with the first area ratio being from 40% to 45%, the amount of chromaticity shift is smallest, which is 0.0320, and therefore, such a range of the first area ratio is most preferable.

As described above, the liquid crystal display device 10 (the display device) according to this embodiment includes the first LED components 25 (the first light emitting component), the second LED components 26 (the second light emitting component), the first color filters 22α, and the second color filters 22β. The dominant wavelength of the first LED components 25 is the first wavelength λ1 included in the wavelength range of blue light. The dominant wavelength of the second LED components 26 is the second wavelength λ2 that is included in the wavelength range of blue light and longer than the first wavelength λ1. The first color filters 22α are disposed on the light exit side with respect to the first LED components 25 and the second LED components 26 and selectively transmit blue light that is light in the wavelength range of blue. The first color filters 22α have a transmission spectrum in which a peak wavelength is the third wavelength λ3 included in the wavelength range of blue. The second color filters 22β are disposed on the light exit side with respect to the first LED components 25 and the second LED components 26 and selectively transmit blue light that is light in the wavelength range of blue. The second color filters 22β have a transmission spectrum in which a peak wavelength is the fourth wavelength λ4 included in the wavelength range of blue. The fourth wavelength λ4 is longer than the third wavelength λ3.

The first LED components 25 emit blue light having the first wavelength λ1 included in the wavelength range of blue light as the dominant wavelength. The second LED components 26 emit blue light having the second wavelength λ2 included in the wavelength range of blue light as the dominant wavelength. The second wavelength λ2 is longer than the first wavelength λ1. Therefore, by appropriately adjusting the amount of light rays emitted by the first LED components 25 and the amount of light rays emitted by the second LED components 26, an image can be displayed with using light that matches circadian rhythm. If the amount of light rays emitted by the first LED components 25 and the amount of light rays emitted by the second LED components 26 are changed, the chromaticity related to the white color of the display image may be changed.

The first color filters 22α and the second color filters 22β are disposed on the light exit side with respect to the first LED components 25 and the second LED components 26 and selectively transmit blue light. In the transmission spectrum of the first color filters 22α, the peak wavelength is the third wavelength λ3 included in the wavelength range of blue. In the transmission spectrum of the second color filters 22β, the peak wavelength is the fourth wavelength λ4 included in the wavelength of blue. The fourth wavelength λ4 is longer than the third wavelength λ3. Therefore, even with the amount of light rays emitted by the first LED components 25 and the amount of light rays emitted by the second LED components 26 being changed, the amount of chromaticity shift that may be caused in the chromaticity related to the white color of the display image is reduced. This can improve display quality.

With the area ratio of the area of the first color filter 22α to the total of the areas of the first color filter 22α and the second color filter 22β being defined as the first area ratio, the first area ratio of the first color filter 22α is from 12% to 68%. If the first area ratio is lower than 12% or greater than 68%, the amount of the chromaticity shift related the white color of the display image is greater than 0.0325 and the change of tint caused in the display image is likely to be recognized. Furthermore, the change ratio of the amount of chromaticity shift to the first area ratio increases. In this respect, with the first area ratio being from 12% to 68%, the amount of chromaticity shift is suppressed to 0.0325 or smaller. Therefore, the change of tint caused in the display image is less likely to be recognized. The change ratio of the amount of chromaticity shift to the first area ratio can become effectively low. Accordingly, the display quality can be improved.

The first area ratio of the first color filters 22α is from 20% to 60%. Compared with the first color filters 22α having the first area ratio that is lower than 20% or greater than 60%, the amount of chromaticity shift can be suppressed to 0.0323 or smaller. Therefore, the change of tint caused in the display image is further less likely to be recognized. The change ratio of the amount of chromaticity shift to the first area ratio can become effectively lower. Accordingly, the display quality can be further improved.

The first area ratio of the first color filters 22α is from 30% to 50%. Compared with the first color filters 22α having the first area ratio that is lower than 30% or greater than 50%, the amount of chromaticity shift is suppressed to 0.0321 or smaller. Therefore, the change of tint caused in the display image is further less likely to be recognized. The change ratio of the amount of chromaticity shift to the first area ratio can become effectively much lower. Accordingly, the display quality can be further improved.

The liquid crystal display device 10 further includes the backlight unit 12 (the lighting device) that supplies light and the liquid crystal panel 11 (the display panel) that displays an image with using the light from the backlight unit 12. The backlight unit 12, which includes the first LED components 25 and the second LED components 26, further includes the wavelength conversion portion 29 that is disposed on the light exit side with respect to the first LED components 25 and the second LED components 26 and converts blue light rays in the wavelength range of blue into light rays in the wavelength ranging from green to red. The liquid crystal panel 11, which includes the first color filter 22α and the second color filter 22β, further includes the third color filter 22γ that selectively transmits green light in the wavelength range of green and the fourth color filter 22δ that selectively transmits red light in the wavelength of red. The wavelength conversion portion 29 converts a portion of the blue light rays emitted by the first LED components 25 and the second LED components 26 into the light rays in the wavelength ranging from green to red. The light rays supplied from the backlight unit 12 to the liquid crystal panel 11 are filtered by the first color filters 22α, the second color filters 22β, the third color filters 22γ, and the fourth color filters 22δ. As a result, blue light rays selectively pass through the first color filters 22α and the second color filters 22β, green light rays selectively pass through the third color filters 22γ, and red light rays selectively pass through the fourth color filters 22δ.

The liquid crystal panel 11 includes the pixel electrodes 20. Each pixel electrode 20 is a portion of the pixel PX, which is a display unit. The pixel electrodes 20 include the first pixel electrode 20α that is disposed to overlap the first color filter 22α and the second color filter 22β, the second pixel electrode 20β that is disposed to overlap the third color filter 22γ, and the third pixel electrode 20γ that is disposed to overlap the fourth color filter 22δ. The first color filter 22α is disposed to overlap a portion of the first pixel electrode 20α. The second color filter 22β is disposed next to the first color filter 22α and overlaps a rest of the first pixel electrode 20α. The first color filter 22α, the second color filter 22β, and the first pixel electrode 20α that are overlapped with each other are configured as the blue pixel BPX that exhibits blue. The third color filter 22γ and the second pixel electrode 20β that are overlapped with each other are configured as the green pixel GPX that exhibits green. The fourth color filter 22δ and the third pixel electrode 20γ that are overlapped with each other are configured as the red pixel RPX that exhibits red. With such a configuration, one blue pixel BPX is displayed with blue light rays including the light rays that pass through the first color filter 22α and the light rays that pass through the second color filter 22β. Compared with a configuration in which one of two blue pixels is displayed with blue light rays including only the light rays that pass through the first color filter 22α and another one of the two blue pixels is displayed with blue light rays including only the light rays that pass through the second color filter 22β, the change of tint that is caused by the change of the amount of light rays emitted by the first LED components 25 and the amount of light rays emitted by the second LED components 26 is further less likely to be recognized.

The backlight unit 12 includes the LEDs 15 (the light source). The LED 15 includes the first LED component 25, the second LED component 26, the case 27 storing the first LED component 25 and the second LED component 26, and the sealing portion 28 with which the case 27 is filled to enclose the first LED component 25 and the second LED component 26. The first LED component 25 and the second LED component 26, which are stored in the case 27, are enclosed with the sealing portion 28 in the case 27. One LED 15 includes the first LED component 25 and the second LED component 26 and therefore, compared with the configuration including one LED including the first LED component 25 and another LED including the second LED component 26, the blue light rays included in the light rays that are supplied to the liquid crystal panel 11 by the backlight unit 12 include the blue light rays having the first wavelength λ1 as the dominant wavelength and the blue light rays having the second wavelength λ2 as the dominant wavelength that are effectively mixed. Accordingly, display quality can be further improved.

The wavelength conversion portion 29 includes the phosphors 30 included in the sealing portion 28. A portion of the blue light rays that are emitted by the first LED component 25 and the second LED component 26 is converted by the phosphors 30 included in the sealing portion 28 into light rays in the wavelength ranging from green to red.

The first wavelength λ1 of the first LED component 25 is from 420 nm to 450 nm and the second wavelength λ2 of the second LED component 26 is from 450 nm to 480 nm. Since the first wavelength λ1 is 420 nm or longer, the light rays emitted by the first LED component 25 do not include high energy violet light (HEV). Therefore, retina cells are less likely to be adversely affected compared to the first LED component having the first wavelength shorter than 420 nm. The first wavelength λ1 is from 420 nm to 450 nm and the second wavelength λ2 is from 450 nm to 480 nm. Therefore, with the first LED component 25 being off and the second LED component 26 being on, melatonin production is preferably suppressed. On the other hand, with the second LED component 26 being off and the first LED component 25 being on, melatonin production is less likely to be suppressed. Therefore, in a day, with the first LED component 25 being off and the second LED component 26 being on in the morning and the second LED component 26 being off and the first LED component 25 being on in the nighttime, the light rays that match the circadian rhythm of humans can be obtained.

### Second Embodiment

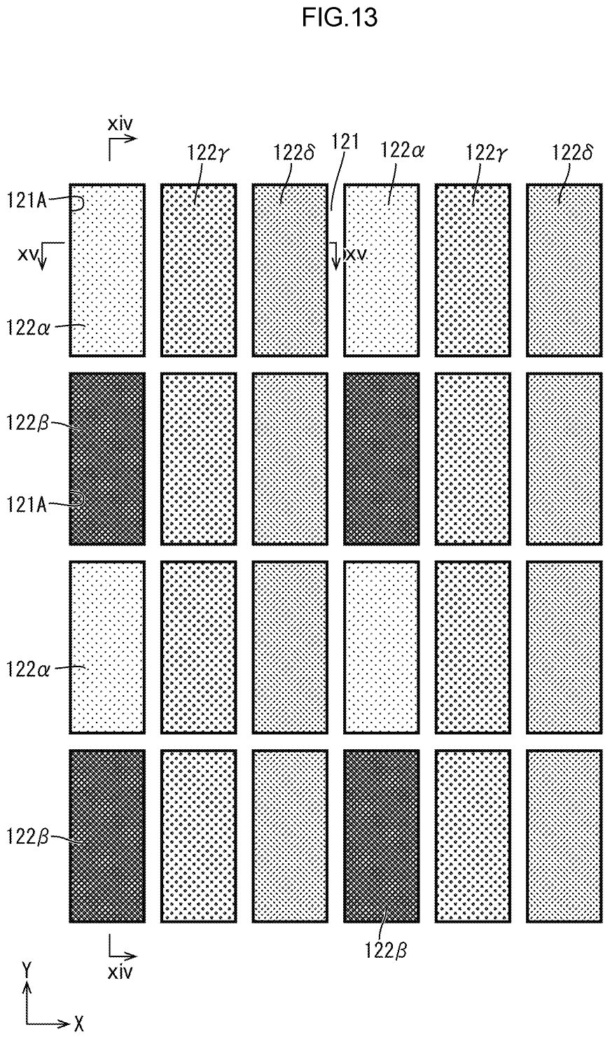

A second embodiment will be described with reference to FIGS. 13 to 17. In the second embodiment, color filters 122 include a first color filter 122α and a second color filter 122β that have configurations different from those of the first embodiment. Configurations, operations, and effects similar to those of the first embodiment will not be described.

As illustrated in FIG. 13, the first color filter 122α and the second color filter 122β are disposed in different openings 121A, respectively. Specifically, the first color filters 122α and the second color filters 122β are arranged next to each other in the Y-axis direction with sandwiching a portion of a light blocking portion 121 extending in the X-axis direction. The first color filters 122α and the second color filters 122β are alternately arranged in the Y-axis direction. Therefore, each of the number of the first color filters 122α and the number of the second color filters 122β is about a half of each of the number of third color filters 122γ and the number of fourth color filters 122δ. Areas (a plan view size) of the first color filter 122α and the second color filter 122β are same and equal to an area of each of the third color filter 122γ and the fourth color filter 122δ. In FIG. 13, the color filters 122α, 122β, 122γ, 122δ are illustrated with different shadings for clarification.

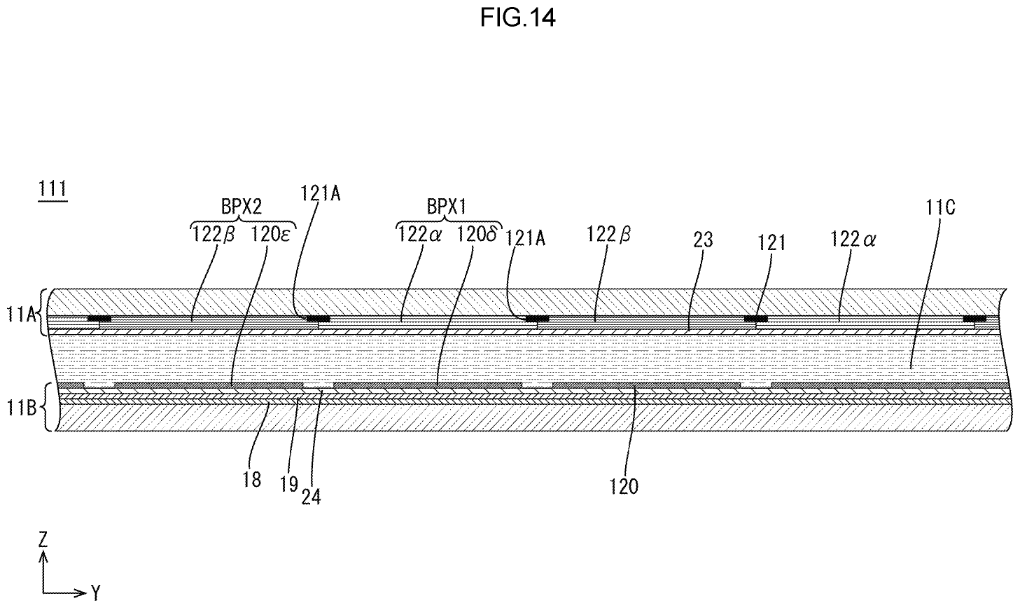

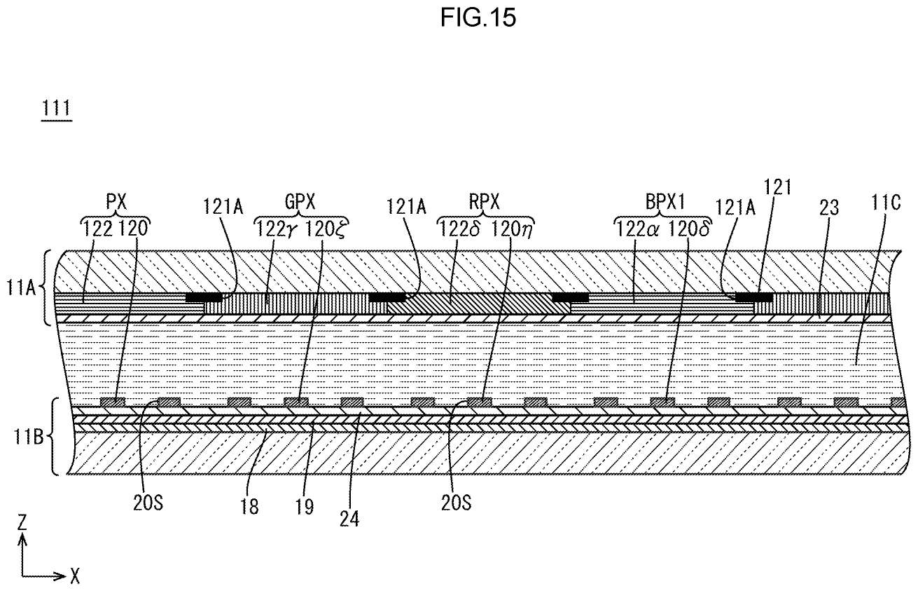

As illustrated in FIG. 14, the first color filter 122α and the second color filter 122β are disposed to overlap pixel electrodes 120, respectively. The pixel electrodes 120 include a fourth pixel electrode 120δ that overlaps the first color filter 122α and a fifth pixel electrode 120ε that overlaps the second color filter 122β. As illustrated in FIG. 15, the pixel electrodes 120 further include a sixth pixel electrode 120ζ that overlaps a third color filter 122γ and a seventh pixel electrode 120η that overlaps a fourth color filter 122δ. In the following description, to describe each of the pixel electrodes 120 separately, δ is added to the symbol representing the fourth pixel electrode, ε is added to the symbol representing the fifth pixel electrode, ζ is added to the symbol representing the sixth pixel electrode, η is added to the symbol representing the seventh pixel electrode. No additional symbol is added to generally refer to the pixel electrodes.

According to this embodiment, as illustrated in FIG. 14, the first color filter 122α and the fourth pixel electrode 120δ that are overlapped with each other are configured as a first blue pixel BPX1 (a blue pixel) that exhibits blue. The second color filter 122β and the fifth pixel electrode 120ε that are overlapped with each other are configured as a second blue pixel BPX2 (a blue pixel). The second blue pixel BPX2 is different from the first blue pixel BPX1. As illustrated in FIG. 15, the third color filter 122γ and the sixth pixel electrode 120ζ that are overlapped with each other are configured as a green pixel GPX that exhibits green. The fourth color filter 122δ and the seventh pixel electrode 120η that are overlapped with each other are configured as a red pixel RPX that exhibits red. With comparing a configuration in which the first color filter 22α and the second color filter 22β are disposed to overlap one pixel electrode 20 as described in the first embodiment, the area of each of the first color filter 122α and the second color filter 122β can be increased. Accordingly, the first color filter 122α and the second color filter 122β can be easily formed in producing a liquid crystal panel.

The first color filter 122α and the second color filter 122β of this embodiment have a same area and are configured such that at least one of the thickness and the density of the included pigment differs between the two color filters. By adjusting at least one of the thickness and the density of the included pigment of the first color filter 122α and the second color filter 122β, the peak intensity of the light having the peak wavelength in the transmission spectrum of each of the first color filter 122α and the second color filter 122β can be adjusted. By adjusting the peak intensity, the amount of chromaticity shift that may be caused by the change of the amount of light rays emitted by the first LED components 25 and the amount of light rays emitted by the second LED components 26 can be preferably reduced (refer to FIG. 4). With the fourth pixel electrode 120δ and the fifth pixel electrode 120ε having the same size, parasitic capacitances created by the gate lines and the source lines near the fourth pixel electrode 120δ and the fifth pixel electrode 120ε are substantially equal. Therefore, high display quality can be preferably maintained.

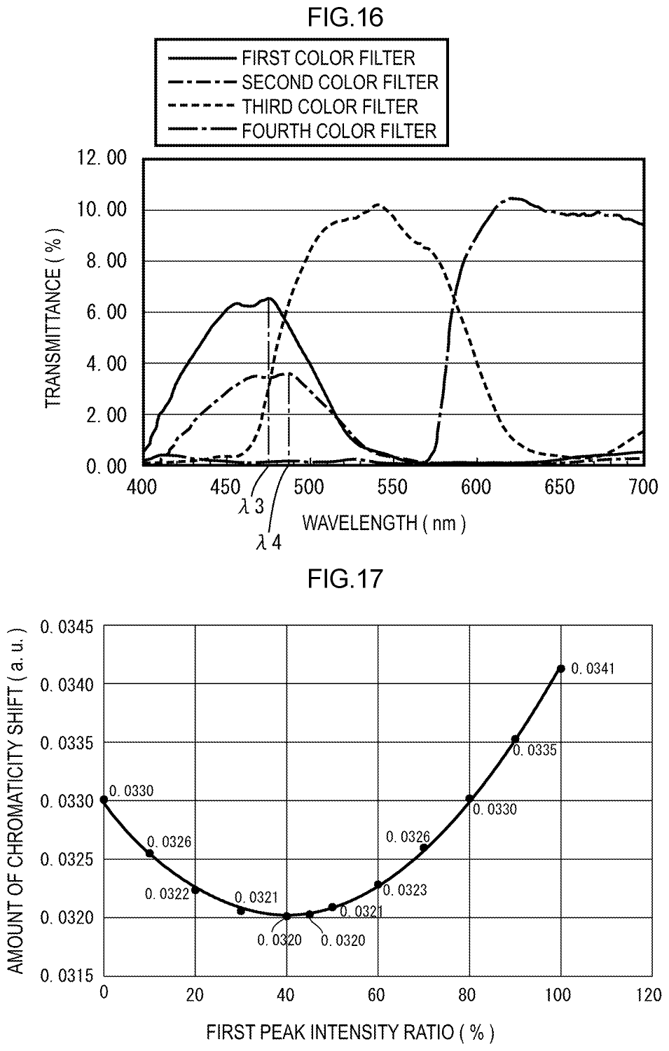

Next, the transmission spectrums of the first color filter 122α and the second color filter 122β will be described with reference to FIG. 16. FIG. 16 illustrates the transmission spectrums of the color filters 122α, 122β, 122γ, 122δ and the lateral axis represents wavelengths (the unit is nm) and the vertical axis represents transmittance of light (the unit is %). According to FIG. 16, in the transmission spectrum of the second color filter 122β, the peak intensity of the light having the peak wavelength is lower than and about a half of the peak intensity of the light having the peak wavelength in the transmission spectrum of the first color filter 122α. Specifically, with the total of the peak intensity of the first color filter 122α and the peak intensity of the second color filter 122β being 100%, the peak intensity ratio of the light having the peak wavelength in the transmission spectrum of the first color filter 122α is 40% and the peak intensity ratio of the light having the peak wavelength in the transmission spectrum of the second color filter 122β is 60%. In the transmission spectrum of the first color filter 122α, the third wavelength γ3, which is a peak wavelength, is about 478 nm. In the transmission spectrum of the second color filter 122β, the fourth wavelength γ4, which is a peak wavelength, is about 488 nm. The transmission spectrum of the second color filter 122β is shifted to the longer wavelengths with respect to the transmission spectrum of the first color filter 122α by 10 nm. The transmission spectrums of the third color filter 122γ and the fourth color filter 122δ are similar to those in FIG. 11 described in the first embodiment.

Next, Verification Experiment 2 was performed to verify how chromaticity related to the white color of a display image changes when the peak intensity in the transmission spectrum of each of the first color filter 122α and the second color filter 122β is changed. In Verification Experiment 2, the ratio of the peak intensity in the transmission spectrum of the first color filter 122α to the total of the peak intensity in the transmission spectrum of the first color filter 122α and the peak intensity in the transmission spectrum of the second color filter 122β is defined as a first peak intensity ratio. With the first peak intensity ratio being changed from 0% to 100%, the amounts of chromaticity shifts that may be caused in the chromaticity related to the white color of the display image were obtained. Specifically, in Verification Experiment 2, the first peak intensity ratio was set to 0%, 10%, 20%, 30%, 40%, 45%, 50%, 60%, 70%, 80%, 90%, 100%. With the first peak intensity ratio being 0%, only the second color filters 122β are formed and the first color filters 122α are not formed. With the first peak intensity ratio being 100%, only the first color filters 122α are formed and the second color filters 122β are not formed. The amount of chromaticity shift represents the same as that described in Verification Experiment 1 of the first embodiment. The Experiment results are illustrated in FIG. 17. FIG. 17 is a graph with the lateral axis representing the first peak intensity ratios (the unit is %) and the vertical axis representing the amounts of chromaticity shifts (no unit).

According to FIG. 17, with the first peak intensity ratio being lower than 12% or greater than 68%, the amount of chromaticity shift is greater than 0.0325. Therefore, the change of tint that is caused in the display image is likely to be recognized. Furthermore, the change ratio of the amount of chromaticity shift to the first peak intensity ratio is high. Therefore, if the first peak intensity ratio is changed due to a production error, the amount of chromaticity shift is largely changed and the change of tint caused in the display image may be likely to be recognized. With the first peak intensity ratio being from 12% to 68%, the amount of chromaticity shift is suppressed to 0.0325 or smaller. Therefore, the change of tint caused in the display image is less likely to be recognized. The change ratio of the amount of chromaticity shift to the first peak intensity ratio is effectively low. Therefore, even if the first peak intensity ratio is changed due to a production error, only a small change is caused in the amount of chromaticity shift and the change of tint caused in the display image is less likely to be recognized.

According to FIG. 17, with the first peak intensity ratio being lower than 20% or greater than 60%, the amount of chromaticity shift is greater than 0.0323. With the first peak intensity ratio being from 20% to 60%, the amount of chromaticity shift is suppressed to 0.0323 or smaller. Therefore, the change of tint caused in the display image is further less likely to be recognized. The change ratio of the amount of chromaticity shift to the first peak intensity ratio becomes effectively lower. Therefore, even if the first peak intensity ratio is changed due to a production error, only a small change is caused in the amount of chromaticity shift and the change of tint caused in the display image is further less likely to be recognized.

According to FIG. 17, with the first peak intensity ratio being lower than 30% or greater than 50%, the amount of chromaticity shift is greater than 0.0321. With the first peak intensity ratio being from 30% to 50%, the amount of chromaticity shift is suppressed to 0.0321 or smaller. Therefore, the change of tint caused in the display image is further less likely to be recognized. The change ratio of the amount of chromaticity shift to the first peak intensity ratio becomes effectively lower and the amount of chromaticity shift is less likely to change. Therefore, even if the first peak intensity ratio is changed due to a production error, only a small change is caused in the amount of chromaticity shift and the change of tint caused in the display image is further less likely to be recognized. Particularly, with the first peak intensity ratio being from 40% to 45%, the amount of chromaticity shift is smallest, which is 0.0320, and therefore, such a range of the first peak intensity ratio is most preferable.

As described above, according to this embodiment, a liquid crystal panel 111 includes the pixel electrodes 120. Each of the pixel electrodes 120 is a portion of the pixel PX, which is configured as a display unit. The pixel electrodes 120 include the fourth pixel electrode 120δ that overlaps the first color filter 122α, the fifth pixel electrode 120ε that overlaps the second color filter 122β, the sixth pixel electrode 120ζ that overlaps the third color filter 122γ, and the seventh pixel electrode 120η that overlaps the fourth color filter 122δ. The first color filter 122α and the fourth pixel electrode 120δ that are overlapped with each other are configured as the first blue pixel BPX1 (blue pixel) that exhibits blue. The second color filter 122β and the fifth pixel electrode 120ε that are overlapped with each other are configured as the second blue pixel BPX2 (blue pixel) that is different from the first blue pixel BPX1, which includes the first color filter 122α and the fourth pixel electrode 120δ. The third color filter 122γ and the sixth pixel electrode 120ζ that are overlapped with each other are configured as the green pixel GPX that exhibits green. The fourth color filter 122δ and the seventh pixel electrode 120η that are overlapped with each other are configured as the red pixel RPX. With comparing a configuration in which the first color filter 122α and the second color filter 122β are disposed to overlap one pixel electrode, the area of each of the first color filter 122α and the second color filter 122β can be increased. Accordingly, the first color filter 122α and the second color filter 122β can be easily formed in producing a liquid crystal panel.

The fourth pixel electrode 120δ and the fifth pixel electrode 120ε have a same area. The first color filter 122α and the second color filter 122β have a same area and are configured such that at least one of the thickness and the density of the included pigment or dye differs between the two color filters. By adjusting at least one of the thickness and the density of the included pigment or dye of the first color filter 122α and the second color filter 122β, the peak intensity of the light having the peak wavelength in the transmission spectrum of each of the first color filter 122α and the second color filter 122β can be adjusted. By adjusting the peak intensity, the amount of chromaticity shift that may be caused by the change of the amount of light rays emitted by the first LED components 25 and the amount of light rays emitted by the second LED components 26 can be preferably reduced. With the fourth pixel electrode 120δ and the fifth pixel electrode 120ε having the same size, parasitic capacitances created by the lines, which may be formed near the fourth pixel electrode 120δ and the fifth pixel electrode 120ε, are substantially equal. Accordingly, the voltage holding ratios of the fourth pixel electrode 120δ and the fifth pixel electrode 120ε are equalized and high display quality can be preferably maintained.

With the ratio of the peak intensity of the first color filter 122α to the total of the peak intensity of the first color filter 212α and the peak intensity of the second color filter 122β being defined as the first peak intensity ratio, the first peak intensity ratio of the first color filter 122α is from 12% to 68%. If the first peak intensity ratio is lower than 12% or greater than 68%, the amount of the chromaticity shift related the white color of the display image is greater than 0.0325 and the change of tint caused in the display image is likely to be recognized. Furthermore, the change ratio of the amount of chromaticity shift to the first peak intensity ratio increases. In this respect, with the first peak intensity ratio being from 12% to 68%, the amount of chromaticity shift is suppressed to 0.0325 or smaller. Therefore, the change of tint caused in the display image is less likely to be recognized. The change ratio of the amount of chromaticity shift to the first peak intensity ratio can become effectively low. Accordingly, the display quality can be improved.

The first peak intensity ratio of the first color filters 122α is from 20% to 60%. Compared with the first color filter 122α having the first peak intensity ratio that is lower than 20% or greater than 60%, the amount of chromaticity shift can be suppressed to 0.0323 or smaller. Therefore, the change of tint caused in the display image is further less likely to be recognized. The change ratio of the amount of chromaticity shift to the first peak intensity ratio can become effectively lower. Accordingly, the display quality can be further improved.

The first peak intensity ratio of the first color filters 122α is from 30% to 50%. Compared with the first color filters 122α having the first peak intensity ratio that is lower than 30% or greater than 50%, the amount of chromaticity shift is suppressed to 0.0321 or smaller. Therefore, the change of tint caused in the display image is further less likely to be recognized. The change ratio of the amount of chromaticity shift to the first peak intensity ratio can be effectively much lower. Accordingly, the display quality can be further improved.

### Third Embodiment

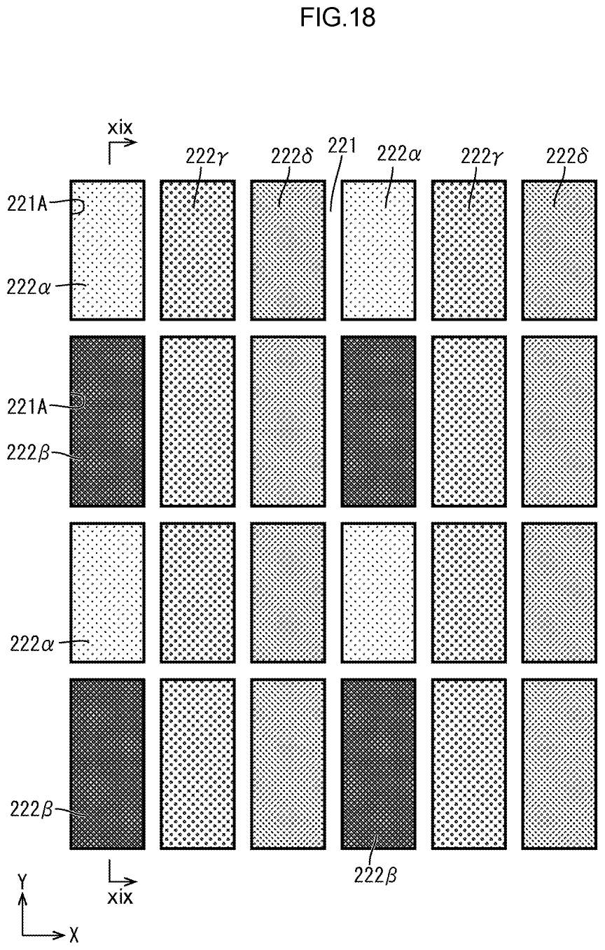

A third embodiment will be described with reference to FIGS. 18 to 20. In the third embodiment, a first color filter 222α and a second color filter 222β have configurations different from those of the above embodiments. Configurations, operations, and effects similar to those of the first embodiment and the second embodiment will not be described.

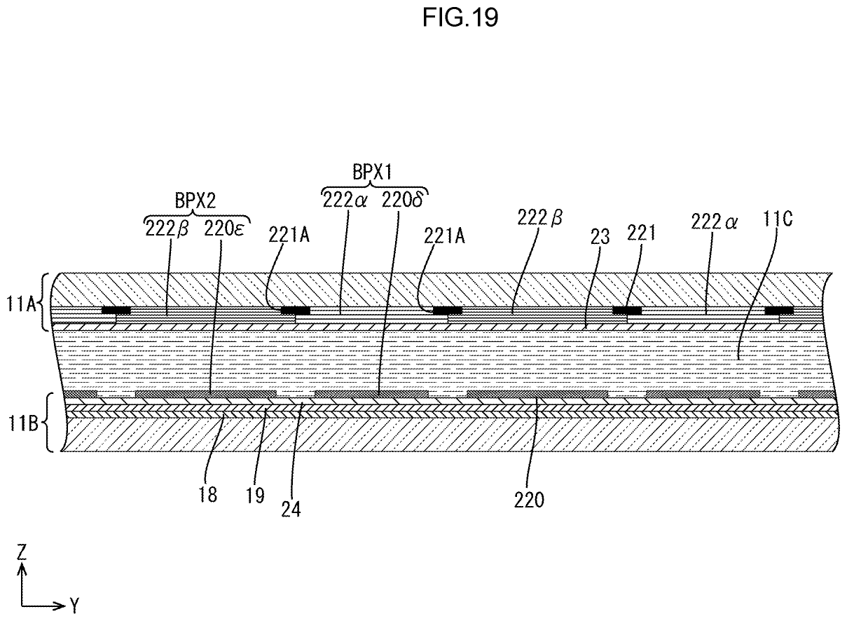

As illustrated in FIGS. 18 and 19, the first color filter 222α and the second color filter 222β are disposed in different openings 221A of a light blocking portion 221, respectively, similarly to the second embodiment. However, this embodiment differs from the second embodiment such that the areas of the first color filter 222α and the second color filter 222β differ from each other. Specifically, with a total of the areas of the first color filter 222α and the second color filter 222β being 100%, the area ratio of the first color filter 222α is about 40% and the area ratio of the second color filter 222β is about 60%. The first color filter 222α and the second color filter 222β have a same dimension in the X-axis direction and different dimensions in the Y-axis direction. As illustrated in FIG. 19, the first color filter 222α and the second color filter 222β are disposed to overlap pixel electrodes 220, respectively. The pixel electrodes 220 include a fourth pixel electrode 220δ that overlaps the first color filter 222α and a fifth pixel electrode 220ε that overlaps the second color filter 222β. The pixel electrodes 220 further include a sixth pixel electrode that overlaps a third color filter 222γ and a seventh pixel electrode that overlaps a fourth color filter 222δ. The fourth pixel electrode 220δ that overlaps the first color filter 222α and a fifth pixel electrode 220ε that overlaps the second color filter 222β have different areas and different dimensions measured in the Y-axis direction. Some of the third color filters 222γ and the fourth color filters 222δ that are disposed in a same row as the first color filter 222α have an area and a dimension measured in the Y-axis direction that are same as the area and the dimension in the Y-axis direction of the first color filter 222α. Similarly, some of the third color filters 222γ and the fourth color filters 222δ that are disposed in a same row as the second color filter 222β have an area and a dimension measured in the Y-axis direction that are same as the area and the dimension in the Y-axis direction of the second color filter 222β. In FIG. 18, the color filters 222α, 222β, 222γ, 222δ are illustrated with different shadings for clarification. The pixel electrodes 220 have the same dimension in the X-axis direction and the dimensions in the Y-axis direction that correspond to those of the color filters 222 that overlap the pixel electrodes 220, respectively.

According to this embodiment, by adjusting the areas of the first color filter 222α and the second color filter 222β, the amount of chromaticity shift that may be caused by the change of the amount of light rays emitted by the first LED components 25 and the amount of light rays emitted by the second LED components 26 can be preferably reduced. The first color filter 222α and the second color filter 222β have a same thickness and a same density of the included pigments. Therefore, the liquid crystal panel can be easily produced. The transmission spectrums of the first color filter 222α and the second color filter 222β are substantially same as the transmission spectrums of the first color filter 22α and the second color filter 22β of the first embodiment (refer to FIG. 11). The peak intensity of the light having the peak wavelength in the transmission spectrum of the first color filter 222α and that in the transmission spectrum of the second color filter 222β are substantially same. The thickness of the filters and the density of pigments included in the filters are adjusted to obtain the substantially same peak light intensity.

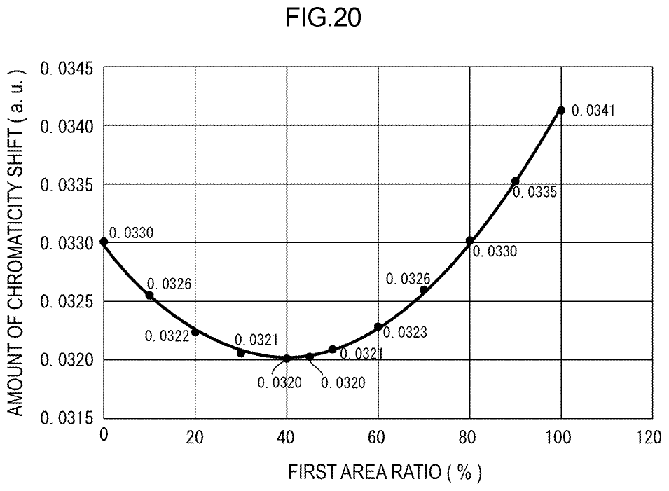

Next, Verification Experiment 3 was performed to verify how chromaticity related to a white color of a display image changes when the area of each of the first color filter 222α and the second color filter 222β is changed. In Verification Experiment 3, the area ratio of the area of the first color filter 222α to the total of the areas of the first color filter 222α and the second color filter 222β is defined as a first area ratio. With the first area ratio being changed from 0% to 100%, the amounts of chromaticity shifts that may be caused in the chromaticity related to the white color of the display image were obtained. Specifically, in Verification Experiment 3, the first area ratio was set to 0%, 10%, 20%, 30%, 40%, 45%, 50%, 60%, 70%, 80%, 90%, 100%. With the first area ratio being 0%, only the second color filters 222β are formed and the first color filters 222α are not formed. With the first area ratio being 100%, only the first color filters 222α are formed and the second color filters 222β are not formed. The amount of chromaticity shift represents the same as that described in Verification Experiment 1 of the first embodiment. The Experiment results are illustrated in FIG. 20. FIG. 20 is a graph with the lateral axis representing the first area ratios (the unit is %) and the vertical axis representing the amounts of chromaticity shifts (no unit).

According to FIG. 20, with the first area ratio being lower than 12% or greater than 68%, the amount of chromaticity shift is greater than 0.0325. Therefore, change of tint that is caused in the display image is likely to be recognized. Furthermore, the change ratio of the amount of chromaticity shift to the first area ratio is high. Therefore, if the first area ratio is changed due to a production error, the amount of chromaticity shift is largely changed and the change of tint caused in the display image may be likely to be recognized. In this respect, with the first area ratio being from 12% to 68%, the amount of chromaticity shift is suppressed to 0.0325 or smaller. Therefore, the change of tint caused in the display image is less likely to be recognized. The change ratio of the amount of chromaticity shift to the first area ratio is effectively low. Therefore, even if the first area ratio is changed due to a production error, only a small change is caused in the amount of chromaticity shift and the change of tint caused in the display image is less likely to be recognized.

According to FIG. 20, with the first area ratio being lower than 20% or greater than 60%, the amount of chromaticity shift is greater than 0.0323. In this respect, with the first area ratio being from 20% to 60%, the amount of chromaticity shift is suppressed to 0.0323 or smaller. Therefore, the change of tint caused in the display image is further less likely to be recognized. The change ratio of the amount of chromaticity shift to the first area ratio becomes effectively lower. Therefore, even if the first area ratio is changed due to a production error, only a small change is caused in the amount of chromaticity shift and the change of tint caused in the display image is further less likely to be recognized.

According to FIG. 20, with the first area ratio being lower than 30% or greater than 50%, the amount of chromaticity shift is greater than 0.0321. In this respect, with the first area ratio being from 30% to 50%, the amount of chromaticity shift is suppressed to 0.0321 or smaller. Therefore, the change of tint caused in the display image is further less likely to be recognized. The change ratio of the amount of chromaticity shift to the first area ratio becomes effectively much lower and the amount of chromaticity shift is less likely to change. Therefore, even if the first area ratio is changed due to a production error, only a small change is caused in the amount of chromaticity shift and the change of tint caused in the display image is further less likely to be recognized. Particularly, with the first area ratio being from 40% to 45%, the amount of chromaticity shift is smallest, which is 0.0320, and therefore, such a range of the first area ratio is most preferable.

As previously described, according to this embodiment, the area of the first color filter 222α differs from the area of the second color filter 222β. By adjusting the areas of the first color filter 222α and the second color filter 222β, the amount of chromaticity shift that may be caused by the change of the amount of light rays emitted by the first LED components 25 and the amount of light rays emitted by the second LED components 26 can be preferably reduced. The thickness and the density of included pigment or dye are same in the first color filter 222α and the second color filter 222β and therefore, the liquid crystal panel can be easily produced.

### Other Embodiments

The technology described herein is not limited to the embodiments described above and illustrated by the drawings. For example, the following embodiments will be included in the technical scope of the present technology.

(1) In the first embodiment and the third embodiment, the specific values of the first area ratio of the first color filter 22α, 222α and the second color filter 22β, 222β can be altered as appropriate. The first area ratio of the first color filter 22α, 222α may be altered as appropriate within the range from 12% to 68% and may be 45% or 50% or may be 51% or more.

(2) In the second embodiment, the specific values of the first peak intensity ratio of the first color filter 122α and the second color filter 122β can be altered as appropriate. The first peak intensity ratio of the first color filter 122α may be altered as appropriate within the range from 12% to 68% and may be 45% or 50% or may be 51% or more.

(3) As a modification of the first embodiment, the first color filter 22α may have a frame-like plan view shape and the second color filter 22β may have a rectangular plan view shape such that the second color filter 22β is surrounded by the first color filter 22α. Or the second color filter 22β may have a frame-like plan view shape and the first color filter 22α may have a rectangular plan view shape such that the first color filter 22α is surrounded by the second color filter 22β. The specific plan view shape of the first color filter 22α and the second color filter 22β and the specific arrangement of the first color filter 22α and the second color filter 22β within the opening may be altered as appropriate.

(4) As modifications of the second and third embodiments, every two or more of the first color filters 122α, 222α and the second color filters 122β, 222β may be alternately arranged in the Y-axis direction.

(5) As a modification of the third embodiment, the first color filters 222α and the second color filters 222β may have a same area and the number of the first color filters 222α may differ from the number of the second color filters 222β. Namely, the operations and effects similar to those of the third embodiment can be obtained as long as the total of the areas of the first color filters 222α differs from the total of the areas of the second color filters 222β.

(6) The specific values of the first wavelength λ1 and the second wavelength λ2 may be altered as necessary. The first wavelength λ1 may be any value selected from the range from 420 nm to 450 nm. The second wavelength λ2 may be any value selected from the range from 450 nm to 480 nm. Other than the above ranges, the first wavelength λ1 and the second wavelength λ2 may be set to any values as appropriate.

(7) The spectrum shape of the light emission spectrum of the LED 15 may be altered from the illustrated ones as appropriate.

(8) The specific values of the third wavelength λ3 and the fourth wavelength λ4 may be altered as necessary. The difference between the third wavelength λ3 and the fourth wavelength λ4 may be any value other than 10 nm or 20 nm (for example, 5 nm).

(9) The spectrum shape of the transmission spectrum of each color filter 22 may be altered from the illustrated ones as appropriate.

(10) The backlight unit 12 may include a first LED and a second LED as the LED 15. The first LED includes the first LED component 25 but not include the second LED component 26 and the second LED includes the second LED component 26 but not include the first LED component.

(11) The phosphors 30 included in the sealing portion 28 may include yellow phosphors instead of the green phosphors and the red phosphors. The yellow phosphors convert the wavelength of blue light and emit yellow light in the wavelength range of yellow light (about 580 nm to about 600 nm). The phosphors 30 may include all of the green phosphors, the red phosphors, and the yellow phosphors.

(12) The sealing portion 28 of the LED 15 may not include the phosphors 30. In such a configuration, a wavelength conversion sheet including the phosphors 30 may be included in the optical member as a wavelength conversion member.

(13) The light blocking portion may be formed in stripes that extend along the Y-axis direction. In such a configuration, the first color filters 22α, 122α, 222α and the second color filters 22β, 122β, 222β may be alternately arranged and continuous to each other in the Y-axis direction and are formed in stripes that extend along the Y-axis direction as a whole. The third color filters 22γ, 122γ, 222γ and the fourth color filter 22δm 122δ, 222δ are formed in stripes that extend along the Y-axis direction.

(14) The color filters 22 may not include pigment but dye.

(15) The color filters 22 may include a yellow color filter that selectively transmit yellow light or a white (transparent) color filter that transmits all the visible light.

(16) The backlight unit 12 may be an edge-light type backlight unit other than a direct-type backlight unit.

(17) Other than the LED 15, an organic electro luminescence (EL) may be used as the light source.

(18) The number, the kinds, and the arrangement order of the optical members 17 may be altered as appropriate.

(19) In the liquid crystal panel 11, 111, the color filters may be included in the array substrate 11B.

(20) The liquid crystal panel 11, 111 may not be a transmissive-type liquid crystal panel but may be a semi-transmissive type liquid crystal panel.

(21) The liquid crystal panel 11, 111 may be displayed in a VA mode or an IPS mode.

(22) The display device may include a display panel (such as an organic electro luminescence display panel) other than the liquid crystal panel 11, 111. With the organic EL display panel being used as the display panel, the organic EL display panel may include white organic light emitting diodes (OLEDs) that emit white light and color filters of three colors that filter the white light emitted by the white OLEDS. The white OLED may include a first light emitting component and a second light emitting component having different dominant wavelengths. The color filters may include a first color filter and a second color filter that have different transmission spectrums.

1. A display device comprising:
a first light emitting component emitting light having a first wavelength that is included in a wavelength range of blue light as a dominant wavelength;
a second light emitting component emitting light having a second wavelength that is included in the wavelength range of blue light as a dominant wavelength and is longer than the first wavelength;
a first color filter that is disposed on a light exit side with respect to the first light emitting component and the second light emitting component and selectively transmits blue light in the wavelength range of blue light, the first color filter having a transmission spectrum in which a peak wavelength is a third wavelength in the wavelength range of blue light; and
a second color filter that is disposed on the light exit side with respect to the first light emitting component and the second light emitting component and selectively transmits the blue light in the wavelength range of blue light, the second color filter having a transmission spectrum in which a peak wavelength is a fourth wavelength in the wavelength range of blue light and the fourth wavelength being longer than the third wavelength.

2. The display device according to claim 1, wherein
a ratio of an area of the first color filter to a total of an area of the first color filter and an area of the second color filter is defined as a first area ratio,
a ratio of peak intensity in the transmission spectrum of the first color filter to a total of peak intensity in the transmission spectrum of the first color filter and peak intensity in the transmission spectrum of the second color filter is defined as a first peak intensity ratio, and
the first area ratio or the first peak intensity ratio of the first color filter is in a range from 12% to 68%.

3. The display device according to claim 2, wherein the first area ratio or the first peak intensity ratio of the first color filter is in a range from 20% to 60%.

4. The display device according to claim 3, wherein the first area ratio or the first peak intensity ratio of the first color filter is in a range from 30% to 50%.

5. The display device according to claim 1, further comprising:
a lighting device supplying light; and
a display panel displaying an image with using the light from the lighting device, wherein
the lighting device includes the first light emitting component, the second light emitting component, and a wavelength conversion portion that is disposed on the light exit side with respect to the first light emitting component and the second light emitting component and converts blue light in the wavelength range of blue into light in a wavelength ranging from green to red, and
the display panel includes the first color filter, the second color filter, a third color filter that selectively transmits green light that is light in a wavelength range of green, and a fourth color filter that selectively transmits red light that is light in the wavelength range of red.

6. The display device according to claim 5, wherein
the display panel includes pixel electrodes, and
the pixel electrodes include a first pixel electrode that is disposed to overlap the first color filter and the second color filter, a second pixel electrode that is disposed to overlap the third color filter, and a third pixel electrode that is disposed to overlap the fourth color filter.

7. The display device according to claim 6, wherein
the first color filter is disposed to overlap a portion of the first pixel electrode, and
the second color filter is disposed to overlap a rest of the first pixel electrode and next to the first color filter.

8. The display device according to claim 5, wherein
the display panel includes pixel electrodes, and
the pixel electrodes include a fourth pixel electrode that is disposed to overlap the first color filter, a fifth pixel electrode that is disposed to overlap the second color filter, a sixth pixel electrode that is disposed to overlap the third color filter, and a seventh pixel electrode that is disposed to overlap the fourth color filter.

9. The display device according to claim 8, wherein
the fourth pixel electrode and the fifth pixel electrode have a same area, and
the first color filter and the second color filter have a same area and at least one of a thickness and a density of included pigment or dye differs between the first color filter and the second color filter.

10. The display device according to claim 8, wherein the first color filter and the second color filter have different areas.

11. The display device according to claim 5, wherein
the lighting device includes a light source, and
the light source includes the first light emitting component and the second light emitting component, a case in which the first light emitting component and the second light emitting component are stored, and a sealing portion with which the case is filled and the first light emitting component and the second light emitting component are enclosed.

12. The display device according to claim 11, wherein the wavelength conversion portion includes phosphor included in the sealing portion.

13. The display device according to claim 1, wherein
the first wavelength of the first light emitting component is in a range from 420 nm to 450 nm, and
the second wavelength of the second light emitting component is in a range from 450 nm to 480 nm.
